(19) United States
(12) Patent Application Publication
(10) Pub. No.: US 2013/0322957 A1
(43) Pub. Date: Dec. 5, 2013

(54) Hollow Rigid Cam Lock

(71) Applicant: James R. Conrad, Salinas, CA (US)

(72) Inventor: James R. Conrad, Salinas, CA (US)

(21) Appl. No.: 13/485,709

(22) Filed: May 31, 2012

(51) Int. Cl. F16B 7/14

(52) U.S. Cl. 403/109.5

(57) ABSTRACT

A cam locking device comprising a male construct and a female construct the female construct for installation in a smaller tube, and the male construct for contacting an interior of a larger tube for impermanently fixing the relative position of the smaller and larger tubes.

This invention allows for two concentric tubes or extrusions (hereafter all referred to as “tubes”) with similar cross sections differing in size to float freely, one inside the other, until the invention is activated at which time the tubes' relative positions become rigidly fixed. The invention may then be deactivated, allowing the tubes to again float freely. The invention may be activated at arbitrary points, and more than one of the invention may be used to join several tubes. Activation and deactivation does not permanently alter or damage the structure of the invention or the tubes.

### BACKGROUND OF THE INVENTION

Many jobs require the performance of specific tasks in inconvenient locations. Inexhaustive examples include painting a high wall or retrieving debris from the center of a large pool. Building temporary structures like scaffolding or bridges which allow workers closer proximity to a given task are time consuming and expensive to construct, or are heavy and awkward to transport, and often require additional precautions to use safely. Frequently, available workspace around task sites cannot easily or safely accommodate a human being, but removal or modification of material to enlarge or make safe a site is rarely viable or economical.

Laborers in search of alternatives increasingly consider ways to extend their reach rather than bring their own bodies closer to the task. A vital tool is a pole or staff which holds an implement at one end that can be manipulated or operated by a worker at the other. Poles of any sizable length are awkward to transport, which has given rise to design of telescoping or collapsible poles made of concentric cylindrical tubes of varying diameters. Such poles can be easily expanded to much greater lengths and made temporarily rigid as to prevent contraction without intervention from the worker.

With the advent of cam locks, telescoping poles can easily accommodate arbitrary lengths without losing rigidity. However, existing cam lock designs suffer from several problems. First, existing designs are prone to breakage under lateral stress typically present in many applications. Weight is also of significant concern. Ideally, rigidity and integrity should be maintained and weight minimized for the cam lock to be effective. Second, when damaged or broken, field repair is impractical, often necessitating complete replacement of the entire telescoping pole. Third, existing cam locks do not easily accommodate tubes of varying diameters, as parts are often specific to one diameter. Finally, there is a need for cam lock designs that allow for passage of material inside the tube beyond the cam lock's installed location. Current designs do not allow fluid to drain through the center of telescoping pole, nor do they allow control wires to run through the center of the pole to a tool or device on the end opposing the worker. Where electrical tools are operated on telescoping poles with such cam locks, wires are typically either be wrapped around the pole or dangle alongside, creating additional inconvenience and safety concerns.

### SUMMARY OF THE INVENTION

What is needed is a low cost, compact, lightweight and durable cam lock that can be quickly and easily repaired onsite without requiring undue replacement of components.

In its basic embodiment, the cam lock comprises a male body and a female body, the male body having a protruding spindle offset from its center and the female body having a cavity capable of accommodating the spindle. The cavity on the female body is typically, but not necessarily offset in proportion to the offset of the spindle on the male body. The shape of the spindle and the cavity are typically cylindrical with circular bases to facilitate the spindle rotating inside the cavity. The male body and female body are also typically cylindrical with circular bases, but further embodiments employ bases which are elliptical or based on other shapes. The top of the spindle is flared such that the outer diameter of the flared portion is larger than the diameter of the cavity. This allows for the spindle, once passed all the way through the female cavity, to remain there.

One cam lock body is sized to fit snugly in the end of the smaller of two tubes. The opposing or free-spinning body is sized such that when the free-spinning body is rotated around the spindle axis, the width of the resulting silhouette becomes larger than the interior of the larger of the two tubes. When the rotation is performed by manipulating the smaller tube while the free-spinning body is inside the larger tube, the free-spinning body is pushed against the side of the larger tube, creating enough friction to prevent the manipulation of the two tubes in relation to each other, forming a rigid implement. When the effect is no longer desired, the tubes may be rotated in a counter direction to relieve the friction, allowing the tubes to once again move freely in relation to each other.

In a further embodiment, n cam locks can be used with n+1 tubes to create a pole with multiple locking segments where n is a positive integer.

In a further embodiment, the cam lock body, to be inserted into the smaller tube, has a ledge or rib preventing insertion beyond a certain point, that body having an outer wall roughly the same size as, or very slightly larger than the interior of the tube, thereby preventing separation once inserted, and the ledge or rib having a size at least slightly larger than the interior of the tube, but preferably larger than the exterior of the tube. This is typically, but not necessarily, the female body.

In a further embodiment, the cam lock body, to be inserted into the larger tube, has a flexible tab which protrudes from the side of that body. This allows that body to have contact with the interior wall of tubes of varying sizes such that a single size body may accommodate several sizes of larger tubes. This is typically, but not necessarily, the male body.

In a further embodiment, both male and female cam lock bodies and the spindle are hollow, allowing material to pass through the cam lock without affecting its function. In one example application, fluid can drain from the interior of one tube through the cam lock into the neighboring tube. In another example application, a wire or other control mechanism can be run through the interior of a telescoping pole.

In a further embodiment, both male and female cam lock bodies and the spindle are hollow and the male cam lock body has one or more thin membranes. The membrane restricts material from passing through the cam lock without affecting its function. The membrane can be removed or punctured by the user to allow material to pass through if desired. The membrane is affixed to, constructed along, or formed at any point along the hollow portion or at the ends of the male cam lock body.

In a further embodiment, a punctured membrane may be replaced by the user, again restricting material from passing through the cam lock.

In a further embodiment, the flared end of the spindle has one or more notches so that it may be contracted, and the spindle removed from the cavity with greater ease, allowing for the separation of the male and female bodies without requiring special tools so as to allow onsite repair.

In a further embodiment, a reinforcement ring is inserted into the spindle after the spindle is passed through the cavity. This prevents the flared end from contracting, and prevents removal of the spindle from the cavity until the reinforcement ring is removed. The reinforcement ring also increases rigidity and structural strength of the spindle which further resists deformation or breakage during use. Because the reinforcement ring is also hollow, materials may flow through the cam lock as described above without hindering its function.

In a further embodiment, the reinforcement ring is held in place by an adhesive.

In a further embodiment, the interior of the spindle is shaped so as to prevent the reinforcement ring from becoming dislodged. This allows the entire cam lock to be quickly assembled from parts and used immediately without additional time to cure.

### BRIEF DESCRIPTION OF THE DRAWINGS

FIG. 1 depicts an exploded view of the invention cam locking device;

FIGS. 2 & 2A depict the cam locking device with its male and female constructions assembled and its reinforcement ring separate and apart from the assembly. FIG. 2 depicts the transparent view. FIG. 2A depicts the opaque view.

FIGS. 3 & 3A depict the cam locking device with its male and female constructions and reinforcement ring assembled. FIG. 3 depicts the transparent view. FIG. 3A depicts the opaque view.

FIG. 4 depicts the assembled cam locking device from the end of the male construction.

FIG. 5 depicts the assembled cam locking device from the end of the female construction with the female construction rotated 180 degrees.

FIG. 6 depicts the assembled cam locking device installed in two tubes.

FIGS. 7, 7A, & 7B depict vertical sections of exploded and assembled views of the cam locking device with two ridges as the locking means for the reinforcement ring.

### DETAILED DESCRIPTION

The following describes preferred embodiments. However, embodiments of the invention are not limited to those embodiments. Therefore, the description that follows is for purpose of illustration and not limitation.

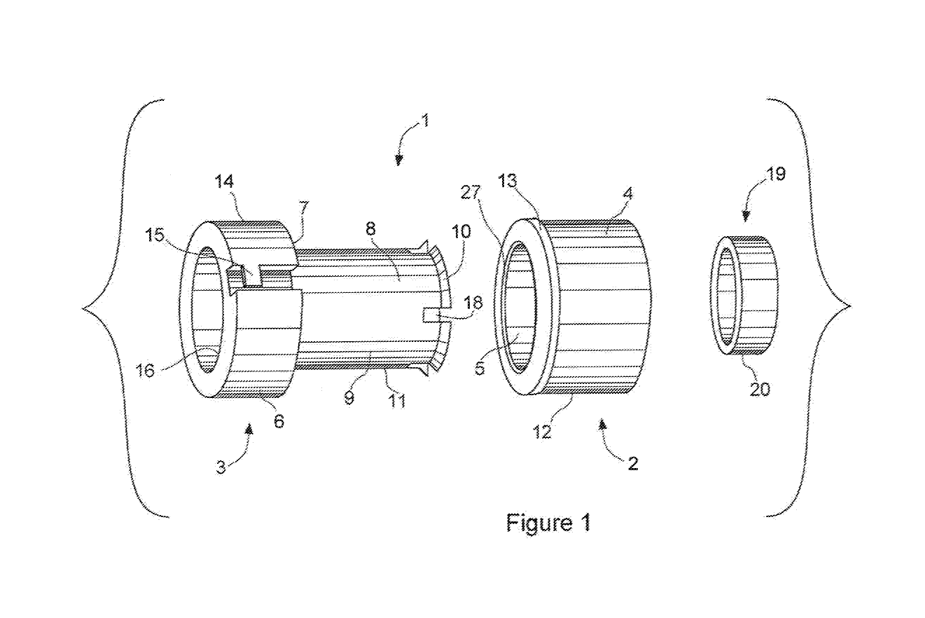

FIG. 1 depicts an exploded view of the invention cam locking device 1 comprising a female construction 2 and a male construction 3.

The female construction 2 further comprises a female body 4, a cylindrical spindle cavity 5 centered about a spindle cavity axis 23, and optionally a radial cutaway or countersink 27 on the end of the spindle cavity 5 accommodating the flared end 10 upon entry into the spindle cavity 5. The diameter of the spindle cavity 5 is typically less than that of the flared end 10 and greater than that of the spindle body 9. The spindle cavity axis 23 is offset from the female body center axis 25.

The male construction 3 further comprises a male body 6, a male body shoulder 7, and a cylindrical spindle 8 protruding from the male body shoulder 7. The spindle 8 is centered about a spindle axis 24. The spindle 8 further comprises a spindle body 9 and a flared end 10. The spindle axis 24 is offset from the male body center axis 26. The spindle body further comprises a spindle outer wall 11.

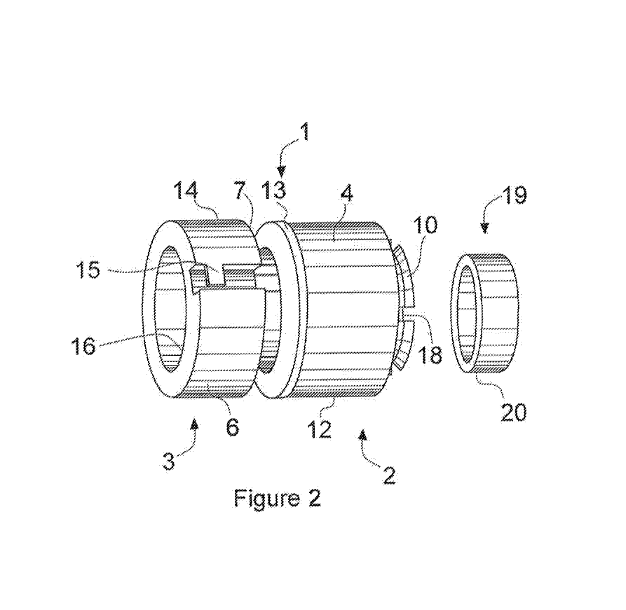

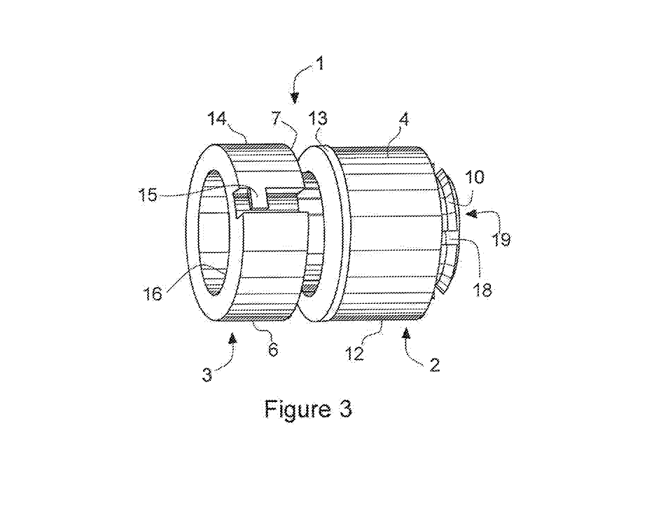

FIGS. 2, 2A, 3 & 3A depict the cam locking device 1 in various states of assembly. The length of the spindle 8 is typically greater than the length of the spindle cavity 5 such that when assembled, the flared end 10 protrudes from the end of the spindle cavity 5 to prevent separation of the male construction 3 and the female construction 2.

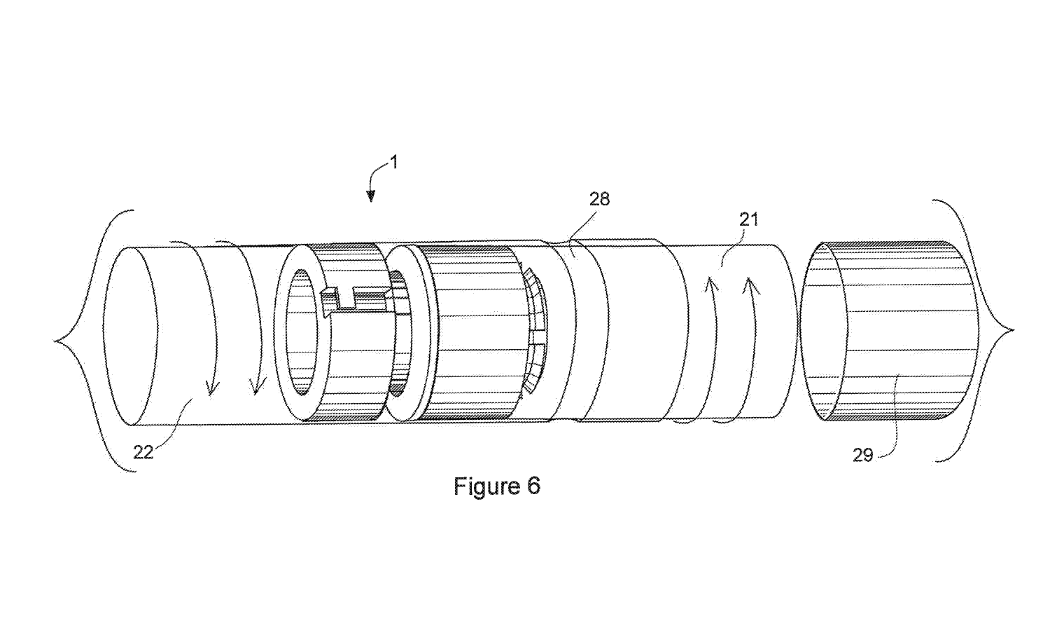

FIG. 6 depicts the assembled cam locking device 1 installed in two tubes. Typically, the female body 4 is inserted into the smaller of two tubes 21. The female body 4 further comprises a female body outer wall 1.2 very slightly larger than the interior of the smaller tube 21, and typically a rib or ledge 13 having a size slightly larger than the interior of the smaller tube 21, but preferably slightly larger than the exterior of the smaller tube 21, thereby preventing insertion of the female body 4 into the smaller tube 21 past the point of the rib or ledge 13. Alternatively, the cam locking device could be manufactured whereby the male body 6 is inserted into the smaller tube 21, and the female construction 2 is free spinning, in which case the male body 6 would further comprise a rib or ledge similar to that depicted.

Optionally, the female body further comprises a rib or ledge 13 having a size larger than the exterior of the smaller tube 21 but smaller than the opening 30 of a guide fitting 29. The guide fitting 29 is secured to the end of the larger of two tubes 22, thereby preventing separation of the tubes until the guide fitting 29 is removed, irrespective of whether the cam lock is in the locked position. Alternatively, a depression ridge 28 in the end of the larger tube 22 could be used instead of the guide fitting 29 to provide a similar function.

Typically, the male construction 3 is free spinning to accommodate the interior of the larger tube 22. The male body 6 further comprises a male body outer wall 14 smaller than the interior of the larger tube 18, and typically a flexible drag tab 15 protruding from the male body outer wall 14. The drag tab 15 contacts the inner wall of the larger tube 22. Alternatively, the cam locking device could be manufactured whereby the male body 6 is inserted into the smaller tube 21, and the female construction 2 is free spinning, in which case the female body 4 would further comprise a flexible drag tab similar to that depicted.

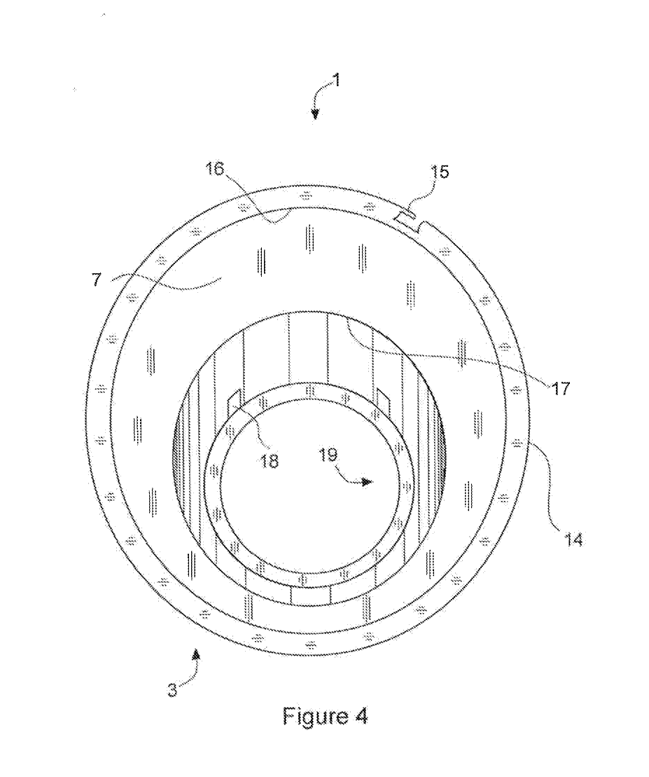

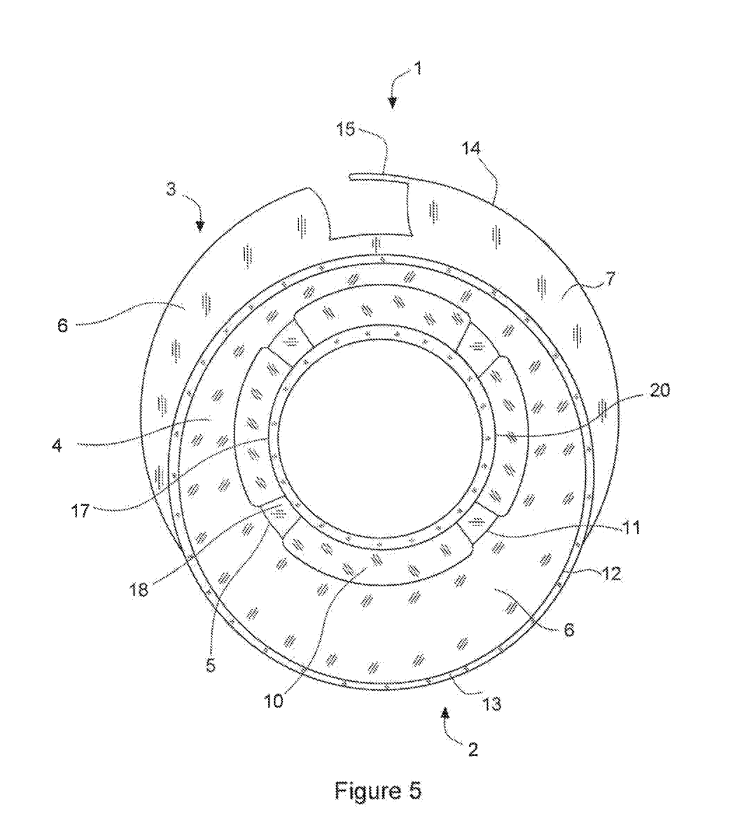

FIGS. 4 & 5 depict the assembled cam locking device 1 from the end of the male construction 3 and from the end of the female construction 2, respectively, with the female construction 2 rotated 180 degrees in FIG. 5.

The male body 6 and the spindle 8 are typically hollow, the male body 6 further comprising a male body inner wall 16, and the spindle further comprising a spindle inner wall 17. This is to allow material to pass through the device without affecting its function. Optionally, the male body inner wall 16 and the spindle inner wall 17 may be of different centers and shapes.

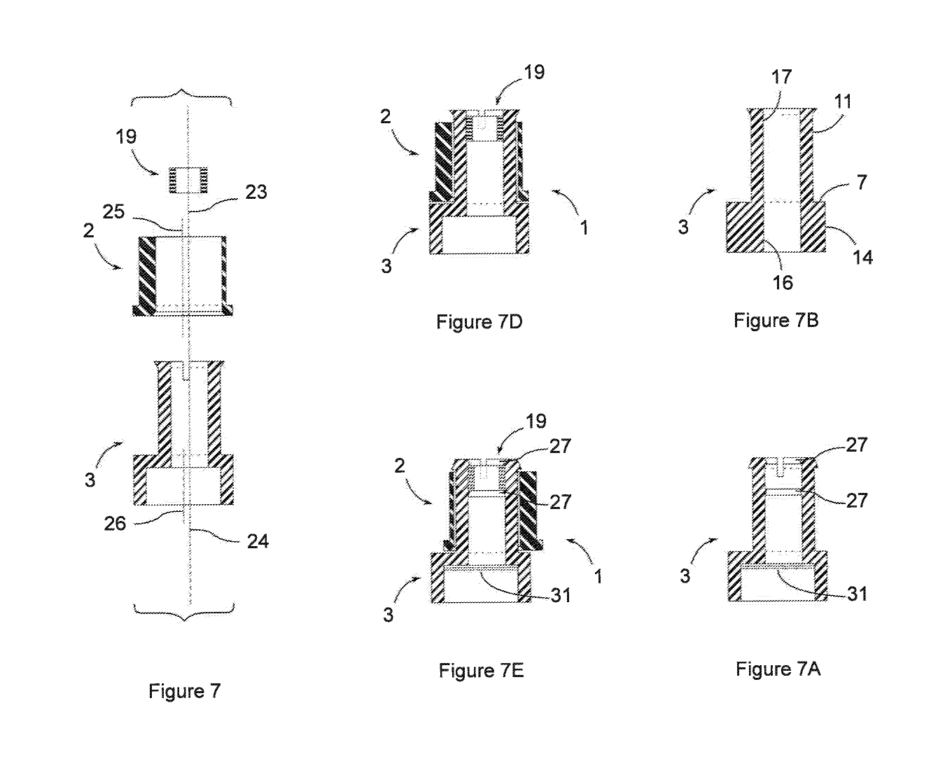

FIGS. 7, 7A, & 7B depict vertical sections of exploded and assembled views of the cam locking device 1 with two ridges 27 as the locking means for the reinforcement ring 19.

Where the male body 6 and the spindle 8 is hollow as described above, the flared end 10 typically further comprises cutaways or notches 18 to allow the flared end 10 to flex more easily while passing through the spindle cavity 5. Typically, the cam locking device 1 further comprises a reinforcement ring 19. The outer diameter of the reinforcement ring 19 is roughly the same as the diameter of the spindle inner wall 17. The reinforcement ring 19 is positioned on the interior of the spindle 8 near the flared end 10 to increase structural strength or to prevent the flared end 10 from passing back through the spindle cavity 5 while the reinforcement ring 19 is in place.

The reinforcement ring 19 is held in place by a locking means which includes, but is not limited to: an adhesive; friction; or surface characteristics of the spindle interior wall 17 and optionally the reinforcement ring outer wall 20 such as notches, grooves, ridges, bumps, protrusions, depressions, etc. FIG. 7A depicts one embodiment having two ridges 27 on either side of the reinforcement ring 19, and a membrane 31 preventing material from passing through the cam locking device 1 until is it punctured or removed.

Typically, but not necessarily, the spindle axis 24 and the spindle cavity axis 23 are offset in similar proportions or by the same amount.

The invention is typically, but not necessarily, manufactured from rigid plastic to reduce cost and weight.

FIG. 7B depicts one embodiment wherein the male body inner wall 16 and the spindle inner wall 17 share a common surface.

1. A cam locking device comprising:
a. a male construct having a longitudinal center, said male construct comprising
a spindle having a longitudinal center offset from and substantially parallel to said longitudinal center of said male construct, said spindle comprising:
i. a spindle body having a width;
ii. a flared end having a width; and
b. a female construct for insertion into a smaller tube, said female construct having:
i. a longitudinal center;
ii. a width such that said female construct fits snugly into an interior of said smaller tube when said female construct is inserted into said smaller tube;
iii. a spindle cavity for receiving said spindle body, said spindle cavity having:
A. a longitudinal center offset from and substantially parallel to said longitudinal center of said female construct;
B. a width less than said width of said flared end and greater than said width of said spindle body.

2. The cam locking device as in claim 1, where said female construct further comprises a rib disposed around a distal end of said female construct, said rib having a width larger than said interior of said smaller tube.

3. The cam locking device as in claim 2, wherein said width of said rib is larger than an opening of a guide fitting, said guide fitting for installation over an end of a larger tube.

4. The cam locking device as in claim 1, where said male construct further comprises a drag tab.

5. The cam locking device as in claim 1, where
said male construction is longitudinally hollow for allowing material to pass through said male construct without affecting its function.

6. (canceled)

7. The cam locking device as in claim 5, further comprising a membrane attached to said male construct for preventing material from passing through said male construct until said membrane is removed or punctured.

8. The cam locking device as in claim 7, where said membrane is replaceable.

9. The cam locking device as in claim 5, where said flared end is cut or notched longitudinally.

10. The cam locking device as in claim 5, further comprising a reinforcement ring in an interior near said flared end.

11. The cam locking device as in claim 10, further comprising a locking means to prevent displacement of said reinforcement ring.

12. The cam locking device as in claim 11, where said locking means comprises a groove in said interior near said flared end accommodating said reinforcement ring.

13. The cam locking device as in claim 11, where said locking means comprises ridges or bumps on said interior near said flared end for surrounding said reinforcement ring.

14. The cam locking device as in claim 11, where said locking means comprises depressions in or protrusions from said interior near said flared end for contacting an outer wall of said reinforcement ring, and where said outer wall of said reinforcement ring further comprises protrusions or depressions conforming to said depressions in or protrusions from said interior near said flared end.

15-21. (canceled)
